(19) United States
(12) Patent Application Publication
(10) Pub. No.: US 2015/0197377 A1
(43) Pub. Date: Jul. 16, 2015

(54) SAFETY DOOR FOR A GAS CYLINDER

(71) Applicant: Sodastream Industries Ltd., Ben Gurion Airport (IL)

(72) Inventors: Eitan LANDAU, Netanya (IL); Doron KROM, Zichron Yaacov (IL); Carmel GOLDSHMID, Kfar Saba (IL); Eyal SHMUELI, Reut (IL)

(21) Appl. No.: 14/591,013

(22) Filed: Jan. 7, 2015

Related U.S. Application Data
(60) Provisional application No. 61/926,327, filed on Jan. 12, 2014.

(51) Int. Cl. B65D 43/16; A23L 2/54

(52) U.S. Cl. CPC B65D 43/16; A23L 2/54

(57) ABSTRACT

A home soda machine includes a housing having a cylinder enclosure and a hinged safety door connected to a back face of the cylinder enclosure. The hinged safety door is rotatable into the cylinder enclosure unless the housing is lying on the back face or a cylinder is in a desired position within the cylinder enclosure.

### CROSS REFERENCE TO RELATED APPLICATIONS

This application claims priority from U.S. provisional patent application 61/926,327, filed Jan. 12, 2014, which is incorporated herein by reference.

### FIELD OF THE INVENTION

The present invention relates to home soda machines generally and to storage for their gas cylinders in particular.

### BACKGROUND OF THE INVENTION

Home soda machines are known in the art. They comprise a gas cylinder, a carbonation unit and a bottle for the liquid to be carbonated. The gas cylinders need to be connected to the carbonation unit safely, such that the cylinder will only release gas when pressed by the carbonation unit. Typically, the connection is made via a screw such that the cylinder has to be screwed into the carbonation unit.

### SUMMARY OF THE PRESENT INVENTION

There is provided, in accordance with a preferred embodiment of the present invention, a home soda machine. The home soda machine includes a housing having a cylinder enclosure and a hinged safety door connected to a back face of the cylinder enclosure. The hinged safety door is rotatable into the cylinder enclosure unless the housing is lying on the back face or a cylinder is in a desired position within the cylinder enclosure.

Moreover, in accordance with a preferred embodiment of the present invention, the hinged safety door includes a hinge located above the door when the housing is upright.

Further, in accordance with a preferred embodiment of the present invention, the hinged safety door is of a sufficient length to touch the back face when the housing is not lying on the back face and the cylinder is not in the desired position.

Still further, in accordance with a preferred embodiment of the present invention, the hinged safety door is at least 1.1 times the diameter of the cylinder enclosure.

There is also provided, in accordance with a preferred embodiment of the present invention, a method for a home soda machine. The method includes having a hinged safety door connected to a back face of a cylinder enclosure of the home soda machine. When the machine is in an upright position or when the machine is lying on the back face, the method also includes the hinged safety door staying out of the way when a cylinder is pushed into the cylinder enclosure. When the machine is vertical or upside down, the method also includes the hinged safety door preventing the cylinder from entering the cylinder enclosure.

Moreover, in accordance with a preferred embodiment of the present invention, the preventing includes the hinged safety door falling towards an opposite face of the cylinder enclosure.

Further, in accordance with a preferred embodiment of the present invention, the preventing includes the hinged safety door crossing a path of the cylinder.

Still further, in accordance with a preferred embodiment of the present invention, the staying includes the hinged safety door lying generally flat against the back face.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic diagram of an exemplary home soda machine;

FIGS. 2A and 2B are schematic diagrams of the home soda machine of FIG. 1 positioned on its back with an additional safety door, designed and operative in accordance with a preferred embodiment of the present invention;

FIG. 3 is a schematic diagram of the home soda machine of FIGS. 2A and 2B when placed in an upright position; and

FIG. 4 is a schematic diagram of home soda machine of FIGS. 2A and 2B when placed on its front face.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that a safety door may be added to the cylinder enclosure of home soda machines to ensure that the user only places the gas cylinder in the enclosure in a safe way and a way that will not damage the front of the machine.

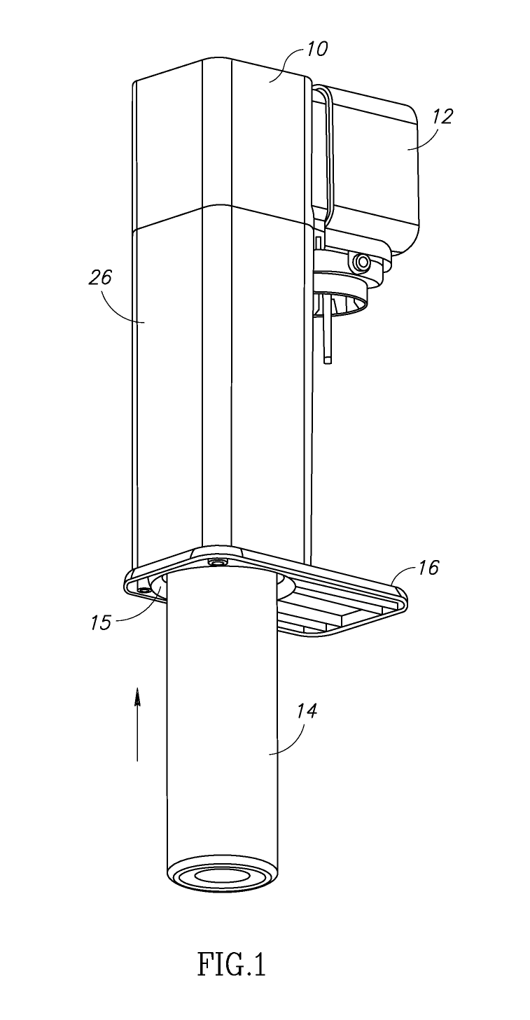

Reference is now made to FIG. 1, which illustrates an exemplary home soda machine. The soda machine has a housing 10, a carbonation unit 12 and a gas cylinder 14. When in operation, housing 10 may stand such that gas cylinder 14 may be vertical.

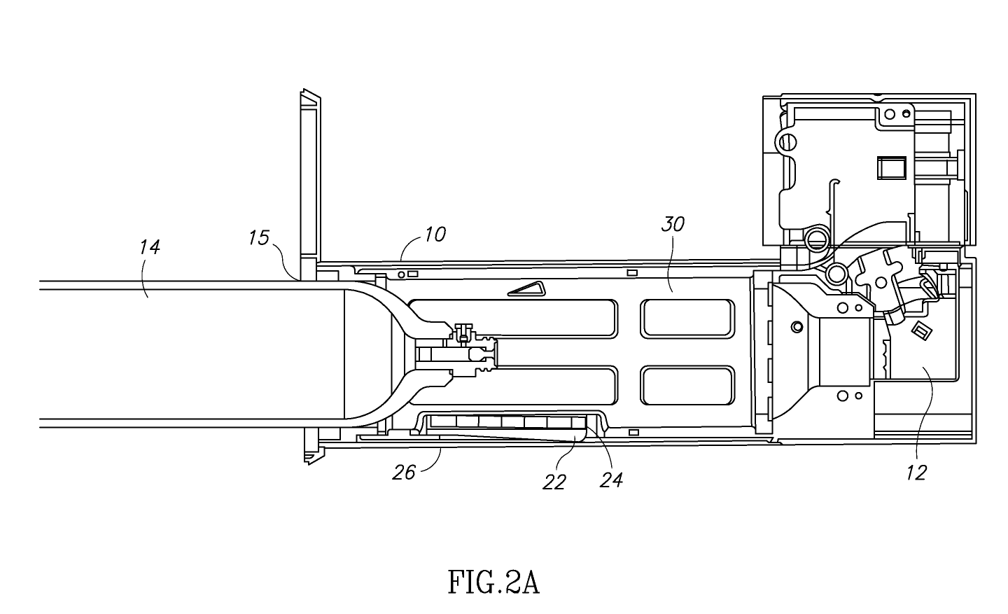

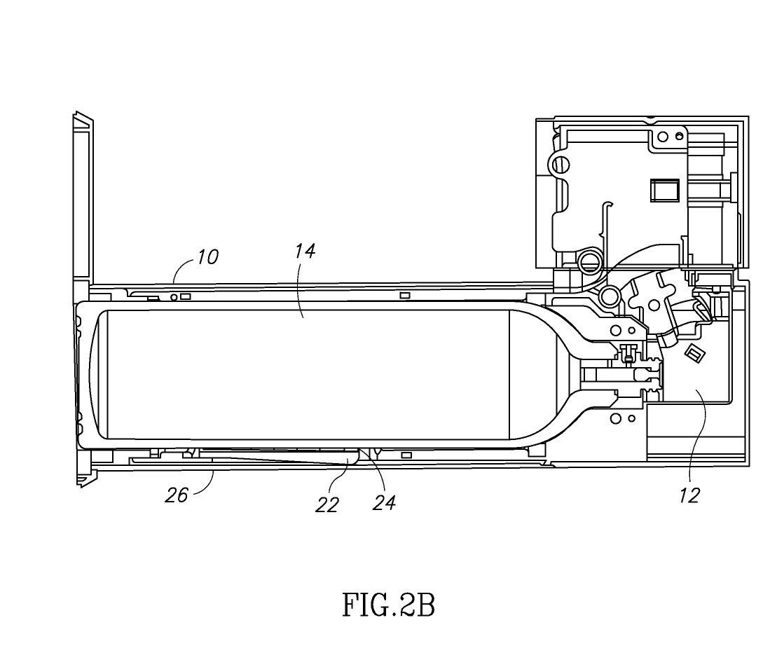

In accordance with a preferred embodiment of the present invention, gas cylinder 14 may be pushed into the cylinder enclosure of housing 10 from a hole 15 in base 16 of housing 10. It will be appreciated that this is not possible if housing 10 is vertical and upside down. Instead, housing 10 may be placed on its back, as shown in FIGS. 2A and 2B to which reference is now made, and cylinder 14 may be pushed through hole 15.

In accordance with a preferred embodiment of the present invention, housing 10 may comprise a safety door 22 which may force the user to place housing 10 on its back rather than vertical and upside down or on its front face or any other undesired position.

Safety door 22 may comprise be connected to a back face 26 of housing 10 via a hinge 24. Hinge 24 may be located “above” door 22 when housing 10 is upright. Safety door 22 may be rotatable into the cylinder enclosure unless the housing is lying in its back.

When housing 10 is on its back, in the correct position, door 22 may lie flat against back face 26, as shown in FIG. 2A to which reference is now made. In this correct position, the user may push cylinder 14 into the cylinder enclosure, labeled 30, all the way to carbonation unit 12. Door 22 does not disturb this motion.

Moreover, after cylinder 14 is screwed into carbonation unit 12, the home soda machine may be righted to its upright position and safety door 22 may not move, since cylinder 14 may generally hold it in position, as shown in FIG. 2B to which reference is now briefly made.

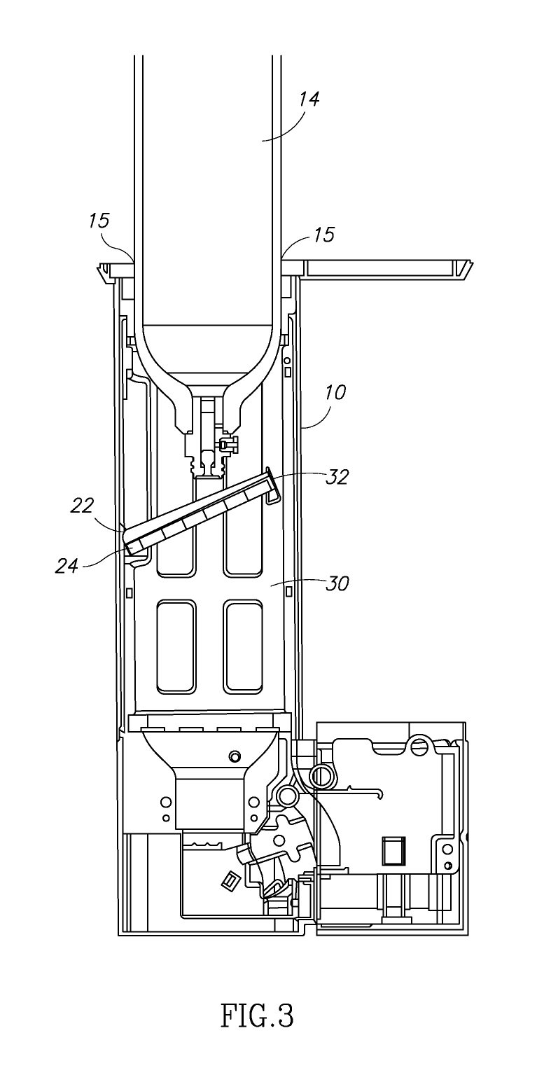

However, if, as shown in FIG. 3 to which reference is now made, a user mistakenly holds housing 10 vertically and upside down (e.g. so as to access hole 15), safety door 22 may now be “above” hinge 24 and thus, since it is without support, may “fall” towards an opposite face, labeled 32, of cylinder enclosure 30. Door 22 may be of a sufficient length to touch opposite face 32. For example, it may be at least 1.1 times the diameter of cylinder enclosure 30.

As can be seen from FIG. 3, safety door 22 may cross the path of cylinder 14 and may thus prevent the user from pushing cylinder 14 into housing 10 from this position.

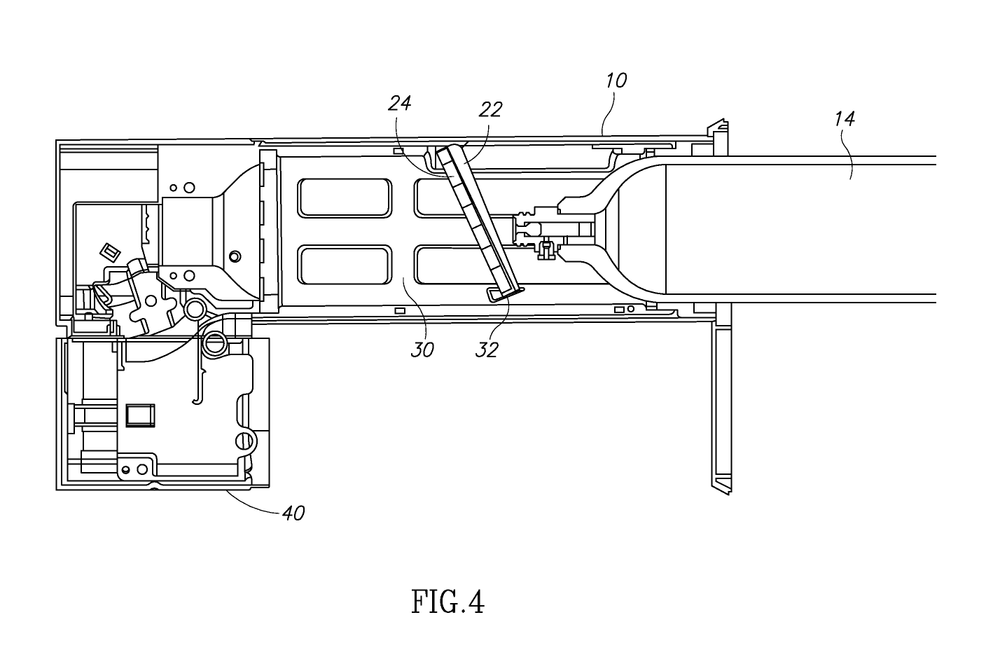

Similarly, as shown in FIG. 4 to which reference is now made, if a user mistakenly holds housing 10 on its front face, labeled 40, this may also cause safety door 22 to fall towards opposite face 32 of cylinder enclosure 30 and thus, also prevent the user from pushing cylinder 14 into housing 10 from this position.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A home soda machine comprising:
a housing having a cylinder enclosure; and
a hinged safety door connected to a back face of said cylinder enclosure,
said hinged safety door rotatable into said cylinder enclosure unless said housing is lying on said back face or a cylinder is in a desired position within said cylinder enclosure.

2. The machine according to claim 1 and wherein said hinged safety door comprises a hinge located above said door when said housing is upright.

3. The machine according to claim 1 and wherein said hinged safety door is of a sufficient length to touch said back face when said housing is not lying on said back face and said cylinder is not in said desired position.

4. The machine according to claim 1 and wherein said hinged safety door is at least 1.1 times the diameter of said cylinder enclosure.

5. A method for a home soda machine, the method comprising:
having a hinged safety door connected to a back face of a cylinder enclosure of said home soda machine;
when said machine is in an upright position or when said machine is lying on said back face, said hinged safety door staying out of the way when a cylinder is pushed into said cylinder enclosure; and
when said machine is vertical or upside down, said hinged safety door preventing said cylinder from entering said cylinder enclosure.

6. The method according to claim 5, wherein said preventing comprises said hinged safety door falling towards an opposite face of the said cylinder enclosure.

7. The method according to claim 5, wherein said preventing comprises said hinged safety door crossing a path of said cylinder.

8. The method according to claim 5, wherein said staying comprises said hinged safety door lying generally flat against said back face.
